(19) United States
(12) Patent Application Publication
(10) Pub. No.: US 2024/0189916 A1
(43) Pub. Date: Jun. 13, 2024

(54) ADJUSTABLE TAILSTOCK OF A WOODTURNING LATHE

(71) Applicant: Penn State Industries, Inc., Philadelphia, PA (US)

(72) Inventors: Edwin LEVY, Philadelphia, PA (US); Marvin LEVY, Philadelphia, PA (US)

(73) Assignee: Penn State Industries, Inc., Philadelphia, PA (US)

(21) Appl. No.: 18/520,715

(22) Filed: Nov. 28, 2023

Related U.S. Application Data
(60) Provisional application No. 63/386,763, filed on Dec. 9, 2022.

(51) Int. Cl. B23B 23/00

(52) U.S. Cl. CPC B23B 23/005

(57) ABSTRACT

A tailstock of a woodturning lathe with an insert having a morse taper and an adjuster pin capable of passing through the exterior of the insert; an internal collar and engaging with a threaded spindle thereby rendering the threaded spindle fixed. When the pin is removed, the threaded spindle is rotatable (i.e., live). Thus, the tailstock is easily adjustable between live and dead configurations with the simple inclusion or removal of the adjuster pin.

### CROSS-REFERENCE TO RELATED APPLICATION

This application claims the benefit of U.S. Provisional Application No. 63/386,763, filed Dec. 9, 2022, the content of which is incorporated herein by reference in its entirety.

### FIELD OF THE INVENTION

The present invention relates generally to woodturning lathes, and more particularly, to an improved tailstock of a woodturning lathe. The tailstock can be adjusted to be either fixed or rotatable, without the need for additional attachments or elements.

### BACKGROUND

The conventional lathe is a tool for machining longitudinal work pieces with a round cross section, such as wood. A conventional woodturning lathe typically includes a lathe bed whereon a headstock and a tailstock are aligned coaxially along a longitudinal axis, and a carriage is arranged between the headstock and tailstock. The wood is attached to a rotational spindle at the headstock. However, as the dimension of the work piece to be machined by the lathe increases, the weight of the work piece as well as the load in the lathe becomes heavier. Machining work pieces without a counterbalance contact by the tailstock can lead to distortions along the longitudinal axis.

Generally, the tailstock has a main body mounted fixedly to a station frame of the lathe. The tailstock may be equipped with a quill having a protruding center for point-contacting the work piece so as to align the central line of the work piece and the rotational axis of the lathe. In performing the engagement between the work piece and the tailstock, the tailstock is moved manually or by a hydraulic force towards the free end of the work piece till a tight contact is confirmed between the quill and the work piece.

In certain instances, lathe operators desire the quill of the tailstock be rotatable (i. e., live). In other instances, lathe operators desire the quill of the tailstock be fixed (i. e., dead). However, to switch between such configurations—live-to-dead and dead-to-live—the operator has to disassemble the tailstock and change out the quill. Furthermore, the operator may desire to have other tailstock accessories such as chucks or drill bits be capable of being changed from fixed to live without the need to disassemble the tailstock. To provide for such adjustments, the tailstock must be adjustable

Accordingly, there is a need for an adjustable tailstock that is configured to be easily changed between a live and dead configuration without the need for disassembly of the tailstock or removal of elements attached to the tailstock.

### SUMMARY

According to an embodiment of the invention, an adjustable tailstock from a wood lathe is disclosed. The lathe has a headstock and a tailstock aligned coaxially along a longitudinal axis. The adjustable tailstock comprises a housing having an internal passage beginning at a rear housing opening and proceeding through to a front housing opening. The rear housing opening is further from the headstock than the front housing opening. The lathe also includes a longitudinal adjustment shaft a portion of which is located in the internal passage. The longitudinal adjustment shaft is connected to a crank located outside of the internal passage and the crank is adapted to advance or retract the longitudinal adjustment shaft along the longitudinal axis. The tailstock includes a body insert having a head portion and a projection portion, the head portion having a hole projecting radially inward from an exterior surface of the head portion towards the longitudinal axis. The projection portion having a morse taper wherein a portion of the projection portion is located in the internal passage of the housing and the head portion is closer to the headstock than the projection portion. Inside the head portion is a collar. The collar includes a hole projecting radially inward from an exterior surface of the collar towards the longitudinal axis and aligned with the hole in the head portion. The collar is bookended on each side by at least one radial ball bearings where the collar and radial ball bearings are held together with at least one retainer ring on either side. It is understood that the collar, radial ball bearings, and retainer rings are surrounded by the head portion. The tailstock also includes a spindle having an adjustment portion and an attachment portion. The attachment portion included a threaded section. The adjustment portion also has at least one indent projecting radially inward from an exterior surface of the adjustment portion towards the longitudinal axis and aligned with the hole in the collar. The adjustment portion is surrounded by the collar and radial ball bearings allowing the spindle to rotate when the indent in the adjustment portion is not engaged with another element such as an adjustment pin. Finally the tailstock includes an adjustment pin adapted to pass through the hole in the head portion, the hole in the collar and engage the indent in the adjustment portion to prevent the spindle from rotating. The adjustment pins allows a user to liven (i.e., make the tailstock rotatable) or deaden the tailstock (i.e., make the tailstock fixed).

In certain embodiments, the longitudinal adjustment shaft projection portion retainer rings radial ball bearing collar and spindle have internal passages which are connected so there is a single continuous internal passage from the rear of the longitudinal shafter to the front of the spindle. This permits a user to pass a rod through the internal shaft from the back and knock out any elements located in the front.

In certain embodiments, the projection portion morse taper is a #2 morse taper.

In certain embodiments, the diameter of the retainer ring closer to the headstock or the threaded section is larger than the diameter of the retainer ring further from the headstock or threaded section.

In certain embodiments, the retainer ring closer to the headstock or threaded section is seated in a groove located on the interior surface of the head portion.

In certain embodiments, the retainer ring further from the headstock or threaded section is seated in a groove located on the exterior surface of the spindle.

In certain embodiments, the projection portion includes a channel that begins at the end opposite the head portion and proceeds up the exterior surface of the projection portion longitudinally towards the head portion. Furthermore, the channel may proceeds about 95% of the way up the projection portion toward the head portion.

In certain embodiments, two rings project radially outward from the longitudinal axis at the intersection of the attachment portion and the adjustment portion, wherein the ring closer to the threaded section projects out further than the ring further from the threaded section.

In certain embodiments, a ring projects radially inward towards the longitudinal axis at the intersection of the projection portion and the head portion.

### BRIEF DESCRIPTION OF DRAWINGS

The invention is best understood from the following detailed description when read in conjunction with the accompanying drawing. It is emphasized that, according to common practice, the various features of the drawing are not to scale. On the contrary, the various features are arbitrarily expanded or reduced for clarity. Included in the drawing are the following figures:

FIG. 1 is a perspective view of a woodturning lathe according to the present invention;

FIG. 2 is an exploded view of the tailstock of the woodturning lathe of the present invention;

FIG. 3 is a cross sectional view of the tailstock of the woodturning lathe of the present invention;

FIG. 4 is a perspective view of the adjustable spindle of the tailstock of the woodturning lathe of the present invention; and

FIG. 5 is a cross sectional view of the stationary body of the tailstock of the woodturning lathe of the present invention.

### DETAILED DESCRIPTION

The features and benefits of the disclosed pocket and adjustable tailstock of a woodturning lather are illustrated and described by reference to exemplary embodiments. The disclosure also includes the drawing, in which like reference numbers refer to like elements throughout the various figures that comprise the drawing. This description of exemplary embodiments is intended to be read in connection with the accompanying drawing, which is to be considered part of the entire written description. Accordingly, the disclosure expressly should not be limited to such exemplary embodiments illustrating some possible non-limiting combinations of features that may exist alone or in other combinations of features.

In the description of embodiments, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e. g., “horizontally,” “downwardly,” “upwardly,” etc.) should be construed to refer to the orientation as then described or as shown in the drawing under discussion. These relative terms are for convenience of description only and do not require that the apparatus be construed or operated in a particular orientation. Terms such as “attached,” “affixed,” “connected,” “coupled,” “interconnected,” and similar terms refer to a relationship wherein structures are secured or attached to one another either directly or indirectly through intervening structures, as well as both moveable or rigid attachments or relationships, unless expressly described otherwise.

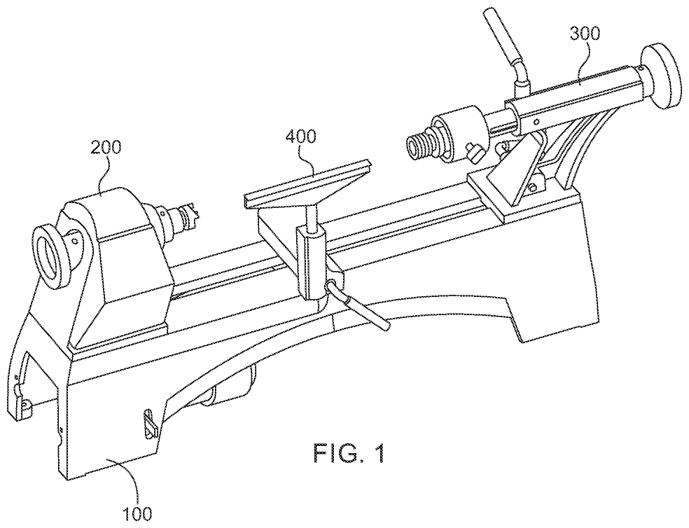

FIG. 1 is provided for illustrating a woodturning lathe which primarily comprises a lathe bed 100 whereon a headstock 200 and a tailstock 300 are aligned coaxially along a longitudinal axis. The woodturning lathe also includes a carriage 400 for carrying a tool-support.

The bed 100, headstock 200, and carriage 400 are fixed. The tailstock 300 is moveable along the longitudinal access up and down the bed 100.

### Housing

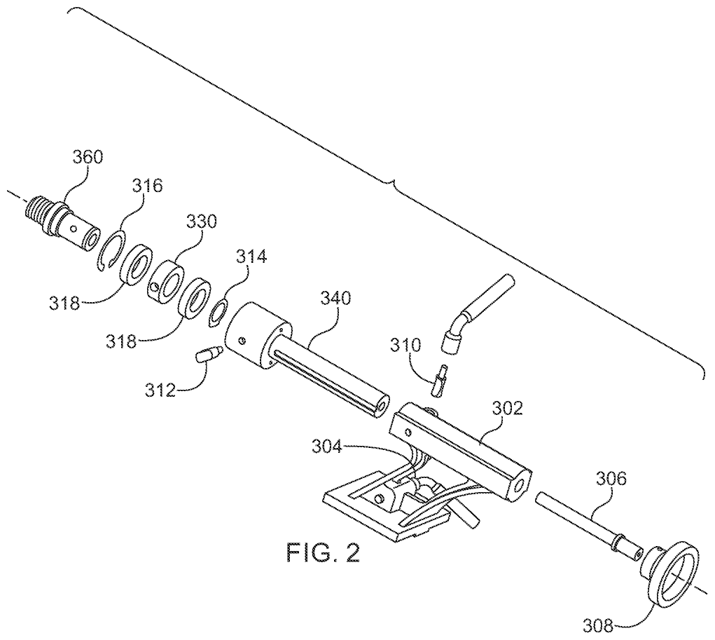

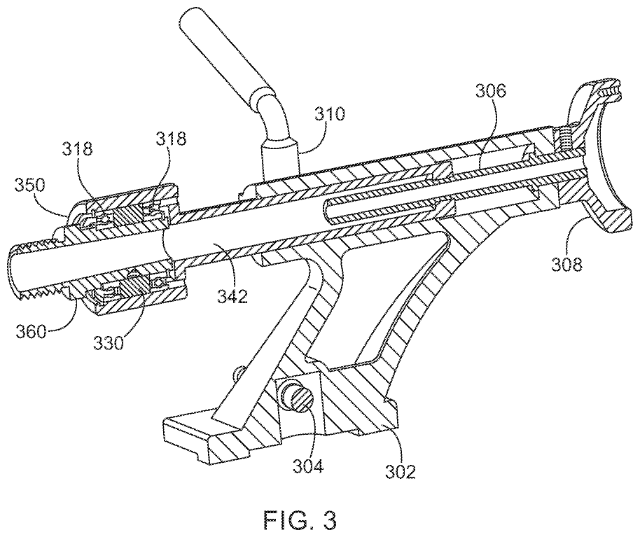

As can be seen in FIGS. 2 and 3, the presently disclosed tailstock includes a housing 302. The tailstock housing 302 may be advanced along the bed 100 and then fixed in a desired longitudinal position using the longitudinal stop 304.

The housing 302 has an internal housing passage that connects a circular rear housing opening to a circular front housing opening to form an internal housing passage. The rear housing opening is further from the headstock 200 than the front housing opening. The diameter of the rear housing opening may be the about the same size as the diameter of the front housing opening. In other embodiments, the diameter of the rear housing opening may be smaller than the diameter of the front housing opening. For example, a housing flange may project partially radially inward from the rear housing opening towards the longitudinal axis resulting in a rear housing opening with a diameter than is less than the front housing opening.

The internal housing passage may also taper. Such a taper may be variable or continuous. Furthermore, such a taper may begin at the front housing opening and end at the rear housing opening or vice versa.

Regardless of design, the internal housing passage contains a portion of a body insert 340 projecting into the internal housing passage through the front housing opening and a portion of a longitudinal adjustment shaft 306 projecting into the internal housing passage through the rear housing opening. The body insert 340 and the longitudinal adjustment shaft 306 are adapted to engage one another and move along the longitudinal axis via the use of a crank 308 operated outside of the housing 302. For example, a user may turn the crank to push the longitudinal adjustment shafter 306 further into the internal housing passage along the longitudinal axis. This movement will in turn push the body insert 340 out of the internal housing passage along the longitudinal axis. In this regard the location of the body insert 340 along the longitudinal axis may be precisely set by the user. Furthermore, the longitudinal location of the body insert 340 may be locked with an Allen key 310.

As will be discussed below, the body insert 340 and longitudinal adjustment shaft 306 both include internal passages providing an uninterrupted passage between the rear of the longitudinal adjustment shaft 306 and the front of the body insert 340. Furthermore, in certain embodiments, such as that depicted in FIG. 3, a portion of the longitudinal adjustment shaft 306 may project into the internal passage of the body insert 340.

### Body Insert

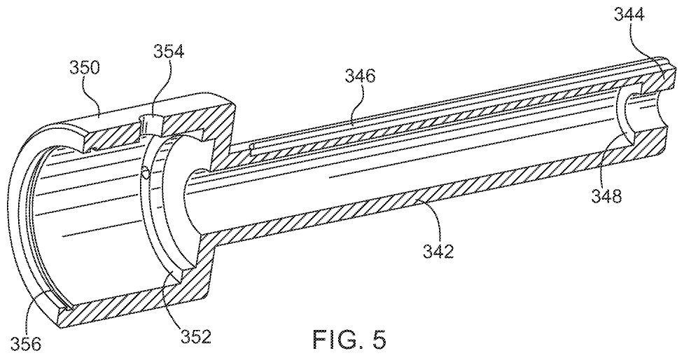

As can be seen in FIGS. 2 and 5, the body insert 340 includes a projection portion 342 attached to a head portion 350. Both portions are hollow cylinders with the diameter of the head portion 350 being larger than the diameter of the projection portion 342. Again, rear openings refer to openings further away from the headstock 200 than front openings when the tailstock is fully assembled. The projection portion 342 also includes a morse taper that terminates at a body termination end 344. The morse taper may be a #1 through #7 Morse taper. For example, it may be a #2 Morse taper.

In certain embodiments, a channel 346 runs in the longitudinal direction along an exterior surface of the projection portion 342 from the body termination end 344 up towards the head portion 350. In such embodiments, the channel 346 may run 50, 60, 70, 80, 90, 95, or 97.5 percent of the longitudinal length between the body termination end 344 and the head portion 350.

In certain embodiments, a flange 348 may project radially inward from the body termination end 344 into the internal passage of the body insert 340 towards the longitudinal axis. The flange 348 will not entirely close the rear opening of the body insert 340. However, the presence of the flange 348 will render the diameter of the rear opening of the body insert 340 smaller than the front opening of the body insert 340.

The head portion 350 includes a ring 352 projecting radially inward towards the longitudinal axis from the location where the head portion 350 connects to the projection portion 342. However, the ring 352 will not block the diameter of the projection portion 342.

The head portion 350 also includes a hole 354 from the exterior surface of the head portion 350 to the interior passage of the head portion 350. The hole allows an adjuster pin 312 to pass through the head portion 350 and engage a collar 330, discussed below, to make the tailstock fixed (i. e., dead). Similarly, the removal of the adjuster pin 312 makes the tailstock rotatable (i. e., live).

Finally, the head portion 350 includes a groove 356 along the internal surface of the head portion 350. The groove 356 is designed to accept a retainer ring 316 to hold the spindle 360 and adjustable internals, discussed below, within the head portion 350.

### Spindle

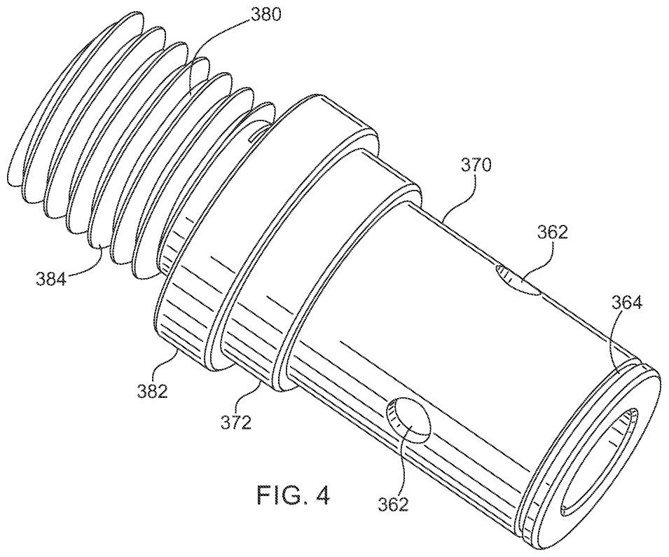

As can be seen in FIGS. 2 and 4, the spindle 360 includes an adjustment portion 370 and an attachment portion 380. Again, both the adjustment portion 370 and the attachment portion 380 are connected, hollow cylinders wherein one continuous internal passage passes from the adjustment portion 370 through the attachment portion 380.

The adjustment portion 370 includes a ring 372 projecting radially outward away from the longitudinal axis from the location where the adjustment portion 370 connects to the attachment portion 380. The purpose of the ring 372 is to keep the spindle 360 and adjustable internals, discussed below, aligned along the longitudinal axis.

The adjustment portion 370 includes at least one indent 362 projecting radially inward from the exterior surface of the adjustment portion 370 towards the longitudinal axis. The indent 362 may even be a hole that passes from the exterior surface of the adjustment portion through to the internal passage of the adjustment portion 370. The indent or hole 362 is adapted to engage an adjuster pin 312 that has passed through the head portion 350, discussed above, and the collar 330 discussed below to render the tailstock fixed (i. e., dead).

Finally, the adjustment portion 370 includes a groove 364 along the exterior surface of the adjustment portion 370. The groove 364 is designed to accept a retainer ring 314 to hold the spindle 360 and adjustable internals, discussed below, within the head portion 350.

The attachment portion 380 includes an attachment ring 382 projecting radially outward away from the longitudinal axis from the location where the adjustment portion 370 connects to the attachment portion 380. The purpose of the attachment ring 382 is to provide a backstop for any elements engaged with the threaded portion 384.

The attachment portion 380 also includes a threaded portion 384 projecting radially outward from the exterior surface of the attachment portion 380 away from the longitudinal axis. The threaded portion 384 begins at the attachment ring 382 and ends at the terminal edge of the attachment portion 380.

### Adjustable Internals

The adjustable internals permit the tailstock 300 to be easily changed between fixed (i. e., dead) and rotatable (i. e., live) configurations. The internals include a cylindrical collar 330 having a hollow internal space with at least one hole passing from the exterior surface of the collar 330 into the hollow internal space.

The collar 330 is bookended on either side by radial ball bearings 318.

The front section, closest to the headstock 200, of the adjustable internals includes a first retainer ring 316 adapted to engage with the groove 356 along the internal surface of the head portion 350. Whereas, the rear section, furthest from the headstock 200, of the adjustable internals includes a second retainer ring 314 adapted to engage with the groove 364 along the external surface of the spindle 360. In certain embodiments, the first retainer ring 316 has a larger diameter than the second retainer ring 314.

In certain embodiments, there is an uninterrupted interior passage between beginning at the rear housing opening and proceeding through the internal passage of the attachment portion 380 of the spindle 360.

### Materials of Manufacture

It will be understood that the pocket 100 and trim piece 200 may be constructed from any bendable material such as metals, polymers, or carbon fiber. In an exemplary embodiment, both the pocket 100 and trim piece 200 are manufactured from extruded aluminum.

The foregoing description of preferred embodiments of the invention should be taken as illustrating, rather than as limiting the present invention. As will be readily appreciated, numerous variations and combinations of the features set forth above can be utilized without departing from the present invention. Such variations are not regarded as a departure from the spirit and scope of the invention, and all such variations are intended to be included within the scope of the invention.

We claim:

1. A lathe having a headstock and a tailstock aligned coaxially along a longitudinal axis, the tailstock comprising:
a housing having an internal passage beginning at a rear housing opening and proceeding through to a front housing opening, wherein the rear housing opening is further from the headstock than the front housing opening;
a longitudinal adjustment shaft a portion of which is located in the internal passage and the longitudinal adjustment shaft is connected to a crank located outside of the internal passage and the crank is adapted to advance or retract the longitudinal adjustment shaft along the longitudinal axis;
a body insert having a head portion and a projection portion, the head portion having a hole projecting radially inward from an exterior surface of the head portion towards the longitudinal axis, the projection portion having a morse taper wherein a portion of the projection portion is located in the internal passage of the housing and the head portion is closer to the headstock than the projection portion;
a collar located within the head portion, the collar having a hole projecting radially inward from an exterior surface of the collar towards the longitudinal axis and aligned with the hole in the head portion, the collar bookended on each side by at least one radial ball bearings, the collar and radial ball bearings held together with at least one retainer ring on either side, and the collar, radial ball bearings, and retainer rings are surrounded by the head portion;
a spindle having an adjustment portion and an attachment portion, the attachment portion included a threaded section, the adjustment portion having at least one indent projecting radially inward from an exterior surface of the adjustment portion towards the longitudinal axis and aligned with the hole in the collar, wherein the adjustment portion is surrounded by the collar and radial ball bearings allowing the spindle to rotate when the indent in the adjustment portion is not engaged with another element; and
an adjustment pin adapted to pass through the hole in the head portion, the hole in the collar and engage the indent in the adjustment portion to prevent the spindle from rotating.

2. The tailstock of claim 1 wherein the longitudinal adjustment shaft projection portion retainer rings radial ball bearing collar and spindle have internal passages which are connected so there is a single continuous internal passage from the rear of the longitudinal shafter to the front of the spindle.

3. The tailstock of claim 1, wherein the projection portion morse taper is a #2 morse taper.

4. The tailstock of claim 1, wherein the diameter of the retainer ring closer to the headstock is larger than the diameter of the retainer ring further from the headstock.

5. The tailstock of claim 1, wherein retainer ring closer to the headstock is seated in a groove located on the interior surface of the head portion.

6. The tailstock of claim 1, wherein the retainer ring further from the headstock is seated in a groove located on the exterior surface of the spindle.

7. The tailstock of claim 1, wherein the projection portion includes a channel that begins at the end opposite the head portion and proceeds up the exterior surface of the projection portion longitudinally towards the head portion.

8. The tailstock of claim 7, wherein the channel proceeds about 95% of the way up the projection portion toward the head portion.

9. The tailstock of claim 1, wherein two rings project radially outward from the longitudinal axis at the intersection of the attachment portion and the adjustment portion, wherein the ring closer to the threaded section projects out further than the ring further from the threaded section.

10. The tailstock of claim 1, wherein a ring projects radially inward towards the longitudinal axis at the intersection of the projection portion and the head portion.

11. An adjustable tailstock comprising:
a body insert having a head portion and a projection portion, the head portion having a hole projecting radially inward from an exterior surface of the head portion towards the longitudinal axis, the projection portion having a morse taper;
a collar located within the head portion, the collar having a hole projecting radially inward from an exterior surface of the collar towards a longitudinal axis passing through the center of the collar and aligned with the hole in the head portion, the collar bookended on each side by at least one radial ball bearings, the collar and radial ball bearings held together with at least one retainer ring on either side, and the collar, radial ball bearings, and retainer rings are surrounded by the head portion;
a spindle having an adjustment portion and an attachment portion, the attachment portion included a threaded section, the adjustment portion having at least one indent projecting radially inward from an exterior surface of the adjustment portion towards the longitudinal axis and aligned with the hole in the collar, wherein the adjustment portion is surrounded by the collar and radial ball bearings allowing the spindle to rotate when the indent in the adjustment portion is not engaged with another element; and
an adjustment pin adapted to pass through the hole in the head portion, the hole in the collar and engage the indent in the adjustment portion to prevent the spindle from rotating.

12. The tailstock of claim 11 wherein the projection portion retainer rings radial ball bearing collar and spindle have internal passages which are connected so there is a single continuous internal passage from the rear of the projection portion to the front of the spindle.

13. The tailstock of claim 11, wherein the projection portion morse taper is a #2 morse taper.

14. The tailstock of claim 11, wherein the diameter of the retainer ring closer to threaded section is larger than the diameter of the retainer ring further from the threaded section.

15. The tailstock of claim 11, wherein retainer ring closer to the threaded section is seated in a groove located on the interior surface of the head portion.

16. The tailstock of claim 11, wherein the retainer ring further from the threaded section is seated in a groove located on the exterior surface of the spindle.

17. The tailstock of claim 11, wherein the projection portion includes a channel that begins at the end opposite the head portion and proceeds up the exterior surface of the projection portion longitudinally towards the head portion.

18. The tailstock of claim 17, wherein the channel proceeds about 95% of the way up the projection portion toward the head portion.

19. The tailstock of claim 11, wherein two rings project radially outward from the longitudinal axis at the intersection of the attachment portion and the adjustment portion, wherein the ring closer to the threaded section projects out further than the ring further from the threaded section.

20. The tailstock of claim 1, wherein a ring projects radially inward towards the longitudinal axis at the intersection of the projection portion and the head portion.
